(19) United States
(12) Patent Application Publication
(10) Pub. No.: US 2008/0238291 A1
(43) Pub. Date: Oct. 2, 2008

(54) COMPACT FLUORESCENT LAMP AND LIGHTING APPARATUS

(75) Inventors: Kimiyoshi NAGASAWA, Yokosuka-Shi (JP); Takeo YASUDA, Yokohama-Shi (JP); Hiroshi KUBOTA, Yokosuka-Shi (JP); Shinya HAKUTA, Yokohama-Shi (JP); Kunihiko IKADA, Zushi-Shi (JP); Tetsuya ONO, Yokohama-Shi (JP); Toshiyuki Ikeda, Yokosuka-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOSHIBA LIGHTING & TECHNOLOGY CORPORATION, Shinagawa-Ku (JP)

(21) Appl. No.: 11/861,849

(22) Filed: Sep. 26, 2007

(30) Foreign Application Priority Data
Sep. 29, 2006 (JP) 2006-269162
Feb. 16, 2007 (JP) 2007-036329

(51) Int. Cl. H01J 1/62

(52) U.S. Cl. 313/490

(57) ABSTRACT

A compact fluorescent lamp includes an arc tube having a bulb with a spiral portion formed in at least a portion thereof, the bulb having an electrode sealed in each of both end portions thereof so as to form a discharge path inside, and both the end portions of the bulb opposing to each other at positions inside a portion having a maximum outer diameter of the spiral portion so that the opposing end portions have a minimum distance of 5 to 15 mm; a lighting device lightening the arc tube; a cover member which supports the arc tube and in which the lighting device is arranged; and a base supported by the cover member.

### BACKGROUND OF THE INVENTION

1. Field of the Invention

The present invention relates to a compact fluorescent lamp (or compact self-ballasted fluorescent lamp) including an arc tube which is capable of being substituted for an existing general lighting bulb and also relates to a lighting apparatus using the compact fluorescent lamp.

2. Related Art

There is known a compact fluorescent lamp in which a holder is provided at a base mounted to a socket of a general lighting bulb such as an incandescent lamp and in which an arc tube formed by bending a glass tube bulb and a lighting device are mounted in the holder. The arc tube is covered with a globe.

In recent years, there has been proposed a compact fluorescent lamp for increasing a length of discharge path by forming an arc tube arranged in a narrow space inside the globe into a spirally bending shape so as to achieve miniaturization and realize higher output of the lamp, for example, as shown in Patent Publications 1 and 2 (Japanese Patent Application Laid-Open Publication Nos. 2003-263972 and 2006-222079).

In spiral arc tubes of the compact fluorescent lamps shown in the Patent Publications 1 and 2, both end portions of the bulb forming the ends of the spiral are arranged opposite to each other, and a dimension between the opposing inner surfaces is set approximately equal to that of an inner diameter of the spiral shape.

As shown in the Patent Publication 1, a forming jig is pulled out by reversing the direction of rotation after the temperature of a bulb drops when forming the bulb in a spiral shape, and then, the bulb end is formed into a predetermined shape. Therefore, the formation is made easier by setting the dimension between the opposing inner surfaces of both the end portions of the bulb to that approximately equal to the inner diameter of the spiral. In other words, end portions (lower portions) of the spiral arc tube are formed unchanged with the dimension of an outer diameter of the spiral.

Thus, a holder supporting the arc tube necessarily becomes larger than the dimension of the outer diameter of the spiral. Since the holder is arranged so as to correspond to a thin bottom portion of the globe when constructing the holder by causing it to resemble a silhouette of a general lighting bulb such as an incandescent lamp, a bottom portion of a conventional compact fluorescent lamp becomes thicker, thus, presenting a silhouette different from that of an incandescent lamp.

As described above, it is one of most important matters to make thinner the bottom portion of a compact fluorescent lamp in miniaturization of a compact fluorescent lamp replacing an incandescent lamp.

Furthermore, a recent technology intends to reduce the lamp length and maximum outer diameter length approaching a general lighting bulb defined in JIS (Japanese Industrial Standard), but a cover has a relatively long length and a long maximum outer diameter. Because of this reason, it was difficult for the compact fluorescent lamp to approach the outer appearance of the general lighting bulb and also difficult to approach the lighting characteristic at the lighting time.

Furthermore, in the conventional compact fluorescent lamp, since the maximum outer diameter of a disc-shaped holder is substantially the same as the maximum spiral outer diameter of the acc tube, the outer diameter of the cover also has the same outer diameter. Thus, it was difficult to obtain an outer configuration such that the outer diameter reduces as being directed to the base as in the general incandescent bulb. In addition, since the base end of the globe is apart from the base, there occupies much space of non-illuminated portion near the base, and accordingly, the lighting appearance is far from the image of the general incandescent bulb.

### SUMMARY OF THE INVENTION

The present invention was conceived in consideration of the above circumstances encountered in the prior art mentioned above and an object thereof is to provide a compact fluorescent lamp having an arc tube that enables minimization of a portion corresponding to the bottom portion of a conventional lighting bulb and minimization of an outer diameter of a cover of the bulb so as to possibly reduce non-illuminated portion of the bulb.

Another object of the present invention is to provide a lightening apparatus provided with such compact fluorescent lamp.

The above and other objects can be achieved according to the present invention by providing, in one aspect, a compact fluorescent lamp comprising:

an arc tube having a bulb with a spiral portion formed in at least a portion thereof, the bulb having an electrode sealed in each of both end portions thereof so as to form a discharge path inside, and both the end portions of the bulb opposing to each other at positions inside a portion having a maximum outer diameter of the spiral portion so that the opposing end portions have a minimum distance of 5 to 15 mm;

a lighting device lightening the arc tube;

a cover member which supports the arc tube and in which the lighting device is arranged; and

a base supported by the cover member.

In this aspect, it may be desired that the bulb is provided with a straight fine tube having one end communicating with an inside of the bulb on at least one electrode sealing portion and another end sealed to fill an amalgam therein.

It may be desired that the cover member includes a holder having a portion exposed to an outside and formed of a material having thermal conductivity and supports the arc tube, a partition member supporting a circuit board of the lighting device, and a cover supporting the base. It may be further desired that the holder has substantially a disc shape with an inclined portion formed in an outer periphery thereof by cutting out edges of the disc and a flange portion exposed outward, and the holder supports the arc tube on a disc surface and the globe on an inner surface of the flange portion.

In a further aspect of the present invention, there is also provided a compact fluorescent lamp comprising:

an arc tube spirally formed with a maximum spiral outer diameter;

a cover member mounted with a base on one end side, the arc tube being supported on another end side;

a holder made of metal having an annular outer peripheral surface having a portion mounted on the other end side of the cover member, which is outwardly exposed, and a cylindrical portion integrally formed with an inside of the outer peripheral surface and projecting on the other end side over the outer peripheral surface, the cylindrical portion being formed in such a way that a maximum outer diameter thereof is smaller than the maximum spiral outer diameter of the arc tube, and the arc tube being supported by the cylindrical portion so as to project toward the other end side; and

a lighting device having a substrate mounted with an electronic component constituting a lighting circuit which lights the arc tube, the lighting device being arranged inside the cover member.

In this aspect, it may be desired that the difference between the maximum outer diameter W of the cylindrical portion and the maximum spiral outer diameter D of the arc tube is 2 to 10 mm.

The cylindrical portion of the holder may be coated in white.

According to the above aspects of the present invention, it becomes possible to minimize a portion corresponding to the bottom portion of a lamp so as to provide a compact fluorescent lamp miniaturized up to a shape approximately identical to that of the general lighting bulb such as an incandescent lamp.

A spiral portion of a bulb may form a so-called double discharge path by bending a straight tube into two approximately equal portions in a longitudinal direction and then spirally bending the halved straight tube with an approximate center thereof as a top portion.

Furthermore, a straight tube member may be spirally bent up to ⅔ thereof from one end toward the other end to be a top portion with remaining ⅓ of the straight tube member extending in a direction of the one end through a spirally formed center axis.

Further, in order to make the appearance closely resemble the silhouette of an incandescent lamp, the spiral portion may be shaped like a circular truncated cone positioned on a top portion side including the maximum diameter portion of the globe and having at least partially a spiral portion having a diameter larger than a reduced diameter portion of the globe or like a sphere.

In addition, an electrode sealing portion where an electrode is sealed may be formed to have a predetermined length so as to form a short discharge path portion, and a linear portion may be combined with a spiral portion.

The electrode sealing portions may be formed by linearly extending both end portions of a bulb approximately in parallel or in a curved shape obliquely tilted in an extending direction of the spiral.

A minimum distance between the opposing inner surfaces may be made to 5 to 15 mm, preferably 7 to 12 mm.

The lighting device may be constituted by a circuit board including an inverter circuit mainly including an electronic component that illuminates the arc tube by applying high frequency power of, for example, 10 kHz or more.

The cover member may be constituted by a holder supporting the arc tube, a partition member supporting the circuit board of the lighting device, and a cover supporting the base.

The cover member may be also constituted by a holder and a cover without a partition member by supporting the circuit board of the lighting device using, for example, a synthetic resin holder having electric insulation, and thus, all the members supporting an arc tube, in which a lighting device is arranged, are acceptable without limiting the shape and material of the component and the number of constitutional members.

A base mounted to a socket, into which the general lighting bulb is inserted, may include a normally used E-type screw base.

Furthermore, according to the preferred embodiments, the fine tube need not be exactly straight and substantially straight, for example, approximately straight so as to draw a gentle curve.

The fine tube may be formed integrally with the bulb like a tube by reducing the diameter from one end of the bulb, or a separate fine tube with a small diameter may be sealed to communicate with an inner portion of the bulb. The material may be the same as or different from that of the bulb.

Further, the fine tube may be used as an exhaust outlet of the arc tube.

An amalgam to control mercury vapor pressure may be used, but a fixed amount filled amalgam or pure mercury may also be used.

The holder is preferably formed of metal including at least one of aluminum (Al), copper (Cu), iron (Fe), and nickel (Ni) that have good thermal conductivity. In addition, the holder may be formed of an industrial material such as aluminum nitride (AlN) and silicon carbide (SiC) or formed of a synthetic resin such as highly thermal conductive resin.

The partition member and cover member may be formed of a synthetic resin having an electric and thermal insulation, for example, cheep engineering plastics such as PBT (polybutylene telephthalate).

Furthermore, the holder need not have geometrically exactly circular and may be polygonal such as octagonal or hexagonal. It may be sufficient for the holder to have an approximately disc shape within a permissive range in terms of appearance and design.

The approximately disc shape forming an inclined portion may be formed by cutting out edges of the disc surface linearly or in an R (round) shape.

The inclined portion may have an inclined portion made of a different member such as silicone resin attached continuously or discontinuously to a top surface of the disc surface.

The constitution of the holder for supporting an arc tube is not particularly limited. For example, a bearing hole may be drilled through the disc surface to support an arc tube by inserting an end of the arc tube into the bearing hole, or a recess for support may be formed without forming a through bearing hole by fitting an end of the arc tube into the recess.

It may be desired that flange portion is provided with a ring continuously around the outer periphery of the disc surface, but it is not an essential condition, and ring may be formed to be discontinuous by lacking.

The globe is made of material such as glass and transparent synthetic resin, and means of colorless transparency, coloring, diffusion and the like may be employed according to requested properties or a reflection means such as a reflective coat may be formed partially, for example, on the globe to improve light distribution properties.

Furthermore, according to the aspects of the present invention, since the maximum outer diameter is made smaller than the maximum spiral outer diameter of the arc tube, the outer diameter of the cover member and the outer peripheral surface of the holder can be made smaller, thus realizing a small compact fluorescent lamp having a diameter decreasing toward the base as like a general incandescent bulb. In addition, a reflecting light of the arc tube is irradiated on the peripheral side wall of the cylindrical portion of the holder, and the direct light irradiated from this peripheral side wall and the surrounding portion are also illuminated, thus improving the lighting appearance.

In a further aspect of the present invention, there is also provided a lighting apparatus comprising:

an apparatus body;

a socket provided in the apparatus body; and

a compact fluorescent lamp of the structures mentioned above.

According to the present invention, a compact fluorescent lamp that can be miniaturized up to an approximate or identical shape to that of the general lighting bulb such as an incandescent lamp is used and therefore, light distribution of an apparatus can be considered to be closely resembling or identical to the shape of the general lighting bulb such as an incandescent lamp.

The apparatus body may employ a ceiling mounted type, ceiling suspended type, or a wall mounted type, and may be provided with a globe, a shade, or a reflector as a light controlling body. A compact fluorescent lamp may be exposed.

The lighting apparatus is not limited to one in which one compact fluorescent lamp is mounted to the apparatus body and a plurality of compact fluorescent lamps may be mounted to the lighting apparatus.

The light distribution of an apparatus can be considered to be closely resembling or identical to the shape of the general lighting bulb such as an incandescent lamp. Consequently, a sufficient amount of irradiation of light to a reflector near the socket arranged in the lighting apparatus is ensured and apparatus properties according to optical design of the reflector can be obtained.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a front view showing an arc tube of a compact fluorescent lamp according to a first embodiment of the present invention;

FIG. 2 is an elevational section showing a compact fluorescent lamp of the first embodiment shown in FIG. 1;

FIG. 3 is a sectional view taken along the line III-III in FIG. 2;

FIG. 4 shows a cover of the compact fluorescent lamp, in which FIG. 4A is a perspective view showing the cover viewed from above and FIG. 4B is a perspective view showing the cover viewed from below;

FIG. 5 is a perspective view showing a lapping process of the compact fluorescent lamp;

FIG. 6 is an illustration of a lighting apparatus using the compact fluorescent lamp of the embodiment of the present invention;

FIG. 7 is a sectional view corresponding to FIG. 3 showing a compact fluorescent lamp according to a second embodiment of the present invention;

FIG. 8 is a perspective view showing a modified example of the compact fluorescent lamp with a modified lapping process;

FIG. 9 is a perspective view showing the lapping process of a conventional compact fluorescent lamp.

FIG. 10 is a sectional view showing a compact fluorescent lamp according to third embodiment of the present invention viewed from one side of the substrate;

FIG. 11 is a sectional view showing the compact fluorescent lamp of the third embodiment viewed from a side surface side of the substrate;

FIG. 12 is a partial sectional view of the compact fluorescent lamp of the third embodiment illustrating dimensional relationships between an arc tube and a holder thereof; and

FIG. 13 is a graph showing variation of illumination efficiency based on an application of white color coating.

### DESCRIPTION OF THE PREFERRED EMBODIMENTS

Embodiments of the compact fluorescent lamp and lighting apparatus according to the present invention will be described hereunder with reference to the accompanying drawings. Further, in the following descriptions, terms “upper”, “lower”, “right”, “left” and the like terms are used with reference to the illustration on the drawings of in an actually installed state of the compact fluorescent lamp.

### First Embodiment

This embodiment concerns a compact fluorescent lamp (compact self-ballasted fluorescent lamp) corresponding to the incandescent lamp of 100 W type using an arc tube having a spiral portion and also concerns a downlight lighting apparatus using such lamp. First, the constitution of the arc tube will be described below.

An arc tube 1 is composed of a glass bulb 2 including a spiral portion 10 and electrode sealing portions 20 and 20′ formed in both end portions of the bulb 2.

The spiral portion 10 is molded into a double spiral structure in an approximately cylindrical shape by bending a bulb made of transparent non-lead glass in a straight circular tube shape having an outer diameter of about 10 mm into two approximately equal portions in the longitudinal direction, and then, winding both end portions of the bulb 2 around a forming jig, not shown, so as to form spiral curves with an approximate center of the halved straight tubular member as a top portion 10a.

Further, both the end portions 10b and 10c of the bulb 2 are bent at substantially right angle in a direction opposing to the top portion 10a in parallel to a spiral axis (lamp axis o-o) at spiral ends of the double spiral structure to cause both ends to protrude, and further, both the end portions 10b and 10c are bent so that they come closer toward the lamp axis o-o, and in other words, end portions of the spiral are wound inwardly.

The process of bending both the end portions of the bulb 2 is performed after pulling the forming jig out of the spiral portion 10.

Accordingly, both the end portions 10b and 10c of the bulb 2 having the spiral portion 10 are opposed at positions inside a maximum outer diameter (D1) portion and arranged in a state closer to each other. That is, the end portions of the spiral are opposed by winding inwardly, with a minimum distance “a” between the opposing inner surfaces of 5 to 15 mm, preferably 7 to 12 mm. In this embodiment, the minimum distance “a” is set at about 10 mm

A pair of electrodes 20a and 20b are sealed in both the end portions 10b and 10c of the bulb 2 of the structure mentioned above to form the electrode sealing portions 20 and 20′ respectively.

Accordingly, the spiral portion 10 and both the end portions 10b and 10c are continued, and the electrode sealing portions 20 and 20′ are formed to both the end portions so as to form one long discharge path inside.

If the dimension “a” between the opposing inner surfaces is made shorter than 5 mm, the temperature of the electrode portions rises, which may easily cause degradation of the electrode. In addition, the temperature of supplementary amalgam sealed in the bulb ends also rises, making it difficult to obtain desired luminescent properties. Further, portions near the electrodes are likely heated abnormally in an end stage of life of the arc tube.

If the dimension “a” between the opposing inner surfaces exceeds 15 mm, the distance to the globe root portion becomes shorter, and both the end portions are likely to cast a shadow to be reflected on the globe. Particularly, because the portions near the electrodes forming the root portion contain a portion that does not emit light and, thus, are likely shadowed due to a difference in brightness. If, on the contrary, the globe root portion is moved away, a shadow is less likely to be cast, but a neck portion of the lamp becomes thicker so that it becomes impossible to come closer to a silhouette of an incandescent lamp. Moreover, strength of an arc tube, particularly, strength in an opening direction in both the end portions is lowered, thus making the arc tube more likely to damage.

Filament coil electrodes made of tungsten, for example, are used as a pair of electrodes 20a and 20b and are each sealed in the electrode sealing portions 20 and 20′ in a state of temporary fastening by, for example, beads glass.

A fine tube 21 is provided for one of the electrode sealing portion 20 so as to project downward, and the fine tube 21 has one end communicating with the inside of the tube and other end sealed.

The fine tube 21 is formed of a transparent non-lead glass like the glass constituting the bulb 2 and is constituted linearly in parallel with the lamp axis o-o by sealing a main amalgam 21a inside, which is an amalgam.

Incidentally, a short fine tube 22 serving as an exhaust tube is also provided for the other electrode sealing portion 20′.

A phosphor film of rare earth or the like is formed on the inner surface of the bulb 2 almost throughout an entire length thereof and a discharge medium such as argon or krypton is sealed inside.

According to the structure mentioned above, both the end portions, i.e., the electrode sealing portions 20 and 20′, of the bulb 2 having the spiral portion 10 are opposed nearby at positions inside the maximum outer diameter (D1) portion. In other words, the spiral end portions are wound inwardly to constitute the arc tube 1 in an approximately cylindrical shape having the smaller outer diameter of the lower spiral portion.

As will be described later, if the arc tube is used to constitute a compact fluorescent lamp, the portion of the arc tube having the smaller outer diameter is a position corresponding to a root portion N having a shape substantially identical to that of the incandescent lamp.

One example of the arc tube 1 constituted as described above is as follows.

That is, a rated lamp power is about 21 W of the structure such that the dimension of the tube outer diameter of the bulb is about 10 mm, the maximum outer diameter D1 of the spiral portion 10 is about 40 mm, a height dimension H1 is about 76 mm, the dimension “a” between the opposing inner surfaces where the electrode sealing portions 20 and 20′ are opposed is about 10 mm, a dimension “b” between the outer surfaces of the opposing electrode sealing portions 20 and 20′ is about 30 mm, and the length of discharge path between the pair of electrodes 20a and 20b is about 580 mm.

Hereunder, the constitution of a compact fluorescent lamp using the arc tube of the structure mentioned above will be described, in which the arc tube is mentioned as upper side and the base is mentioned as lower side, respectively.

A compact fluorescent lamp 30 includes the arc tube 1 constituted as described above, a lighting device 40 to light the arc tube, a cover member 50 supporting the arc tube in which the lighting device is arranged, a base 60 supported by the cover member, and a globe 70. This compact fluorescent lamp 30 is formed so that an appearance thereof is approximately identical to that of a general lighting bulb such as a 100-W type incandescent lamp. The general lighting bulb is defined by JIS C 7501.

The cover member 50 is constituted by a thermal conduction member having one end outwardly exposed and, includes a holder 51 supporting the arc tube 1, a partition member 52 supporting a circuit board of the lighting device 40, and a cover 53 supporting the base.

The holder 51 is constituted from a metal having a thermal conductivity of 10 W/mk or more, i.e., an aluminum die-cast in the present embodiment, so as to provide substantially a disc shape such that a pair of bearing holes 51a and 51a forming supporting portions are formed on the top surface, which is the surface of the disc, by cutting through the disc.

As described above, the electrode sealing portions 20 and 20′ of the arc tube 1 are arranged so as to be opposed to each other inside the maximum outer diameter D1 of the spiral portion 10, and the minimum distance “a” between the opposing inner surfaces is set to about 10 mm, and therefore, the interval dimension between the pair of bearing holes 51a and 51a may be considered to a small dimension and the holder 51 may be made small.

A space 51b having an opening is formed below the disc, and a ring shaped flange portion 51c exposed outwardly on an outer circumference of the disc is integrally formed so as to project outward and obliquely upward.

A recess 51d in form of a ring-shaped groove is integrally formed all around the inner surface of the ring-shaped flange portion, and a ring-shaped step portion 51e is integrally formed along the entire periphery below the outer surface thereof.

Further, an inclining portion 51f is integrally formed by cutting out corner edges of the entire periphery of the disc surface.

Incidentally, the inclining portion 51f may be formed in an R shape in form of a quarter circle, and almost all circumference may be inclined with the corner edges of the disc remaining.

Lower end portions of both the end portions 10b and 10c of the arc tube are inserted into the pair of bearing holes 51a and 51a of the holder 51, respectively, and a heat-resistant adhesive such as silicone resin and epoxy resin may be applied and fixed to outer surfaces and surroundings of the bearing holes and arc tube end portions.

Accordingly, the arc tube 1 is supported on the top surface, which is the disc surface of the holder 51 in a state that both the end portions 10b and 10c face an upper portion of the inclining portion 51f. Both the end portions 10b and 10c including electrodes of the arc tube 1 are thermally connected to the holder 51 by the adhesive so that heat of the arc tube is efficiently conducted to the holder and radiated.

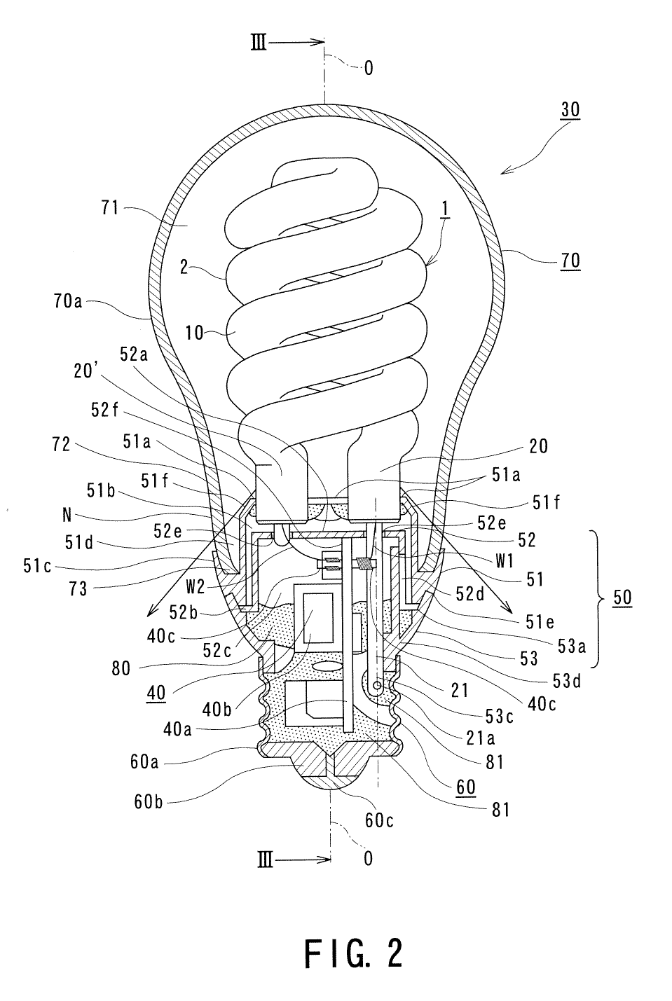

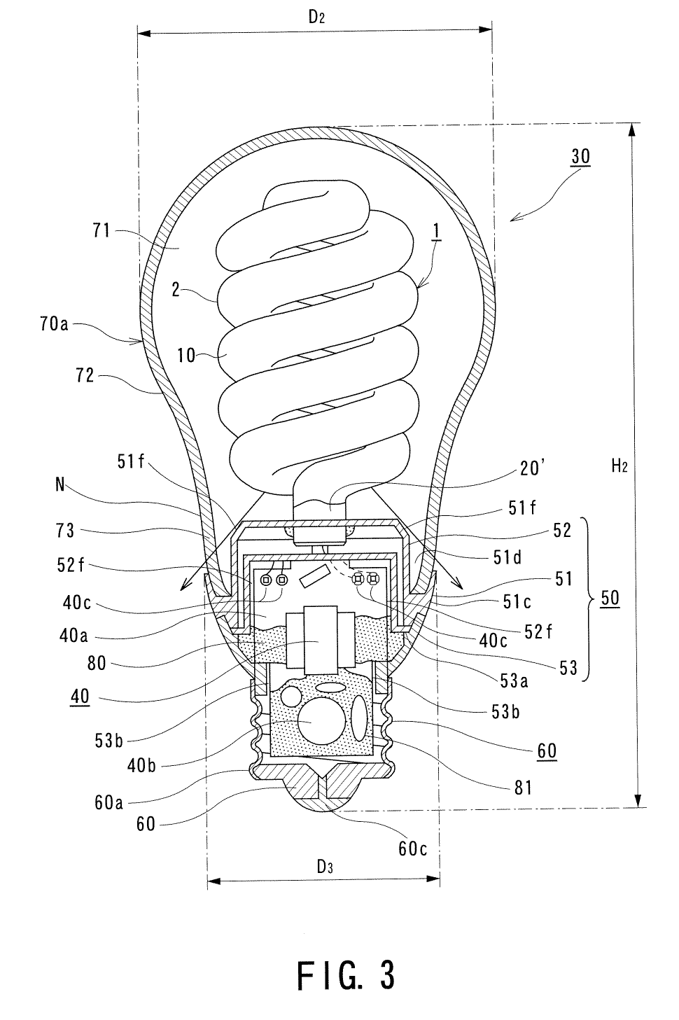

At this time, both the end portions 10b and 10c of the arc tube 1 are supported while facing the inclining portion 51f having the cut-out corner edges, and the light emitted from a vicinity of both the end portions (vicinity of the electrodes) is directed downward without being blocked by the holder edges, and therefore, the vicinity of the bottom of the globe is less likely to be darkened as shown with arrows in FIG. 2 and FIG. 3.

Since the top surface, which forms the disc surface of the holder 15, is composed of aluminum, this surface constitutes a light reflecting surface, and the light emitted downward from the arc tube 1 is reflected upward by the top surface of aluminum, and no further loss is generated.

In the arrangement, lead wires w1 and w2 of the arc tube are led into the space 51b of the holder 51 in a state that the fine tube 21 projects downward.

The partition member 52, in form of disc, is formed of heat-resistant synthetic resin material such as PBT (polybutylene telephthalate). The top surface, forming the disc surface, constitutes a partition plate 52a and integrally forms a cylindrical portion having a mounting portion 52b projecting outward like a flange and integrally forms a space 52c having an opening below the disc.

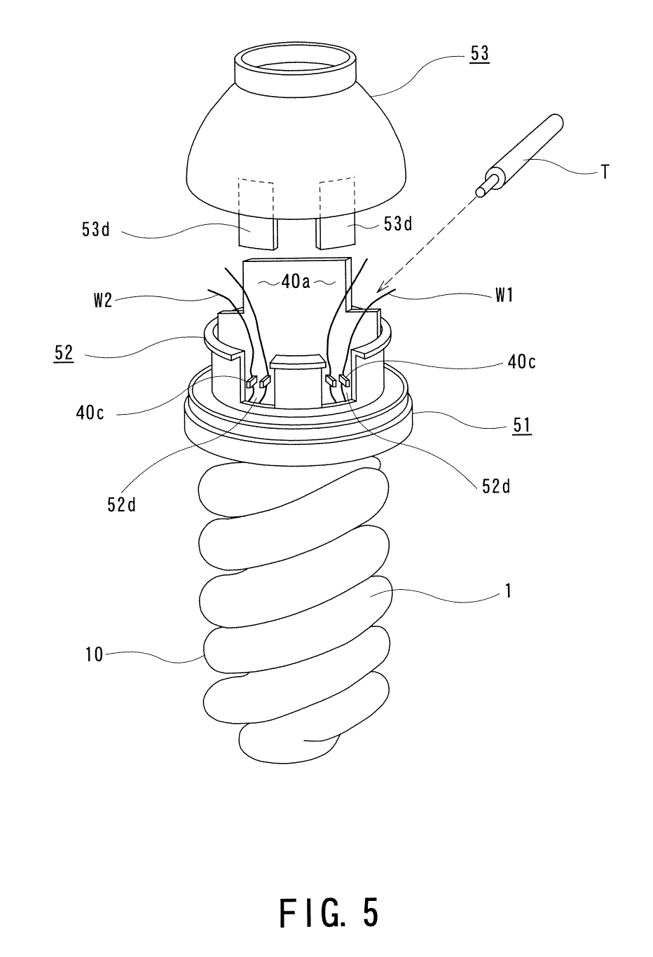

The cylindrical portion of the partition member 52 is formed integrally with a recess 52d for lapping tool insertion by cutting out a side wall of the cylindrical portion at a position opposite to a lapping pin 40c provided so as to project from a circuit board 40a described later (FIG. 2, FIG. 5).

The recess 52d has the shape and size capable of inserting a lapping tool, and two recesses 52d are provided at two locations, each corresponding to a pair of two lapping pins, totally, four lapping pins 40c.

In the partition plate 52a, insertion holes 52e are formed so that the fine tubes 21 and 22 projecting outward from the pair of electrode sealing portions 20 and 20′ of the arc tube 1 and outer wires w1 and w2 are inserted into these holes 52e, respectively.

A pair of lock grooves 52f and 52f supporting, in a longitudinal direction, the circuit board 40a of a lighting circuit described later, are integrally formed on an inner circumferential surface of the partition member 52.

These holder 51 and partition member 52 have been constituted separately, but in the case of a compact fluorescent lamp of relatively low power such as an incandescent lamp of 40 W or 60 W type, they may be integrally formed of synthetic resin such as PBT as a component.

The cover 53 is formed into a cylindrical shape having openings at both ends from heat resistant synthetic resin material such as PBT (polybutylene telephthalate) with a ring-shaped mounting step portion 53a formed at the upper opening.

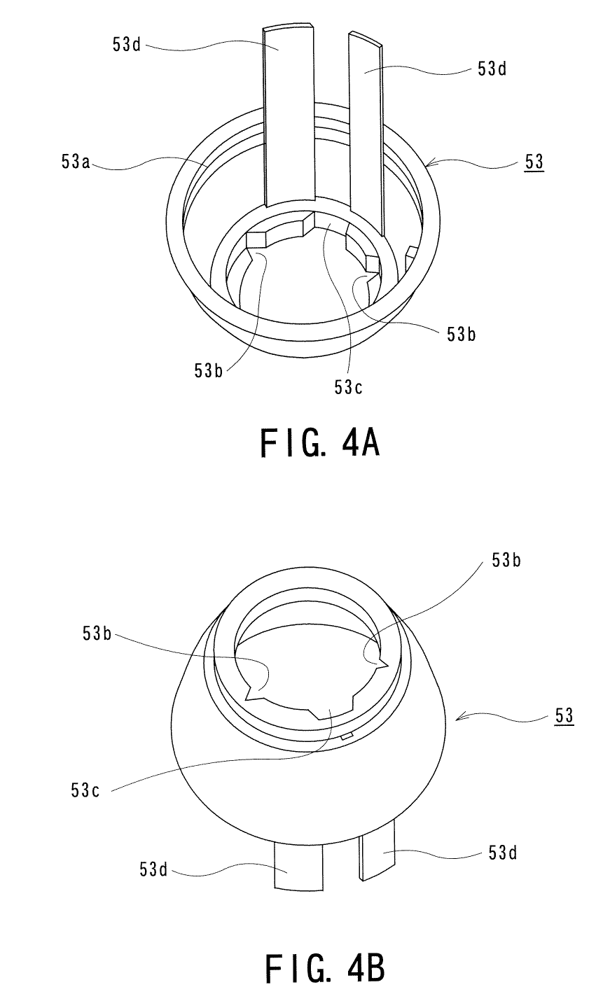

A pair of lock grooves 53b and 53b supporting, in the longitudinal direction, the circuit board 40a of the lighting circuit described later and a cutout portion 53c through which the fine tube 21 is inserted before being locked, are integrally formed on the inner circumferential surface of the lower end opening of the cover 53 as shown in FIG. 4.

A shell 60a of the base 60 described later is mounted on an outer circumferential surface of the lower end opening of the cover 53.

The flange mounting portion 52b of the partition member 52 is fitted into the mounting step portion 53a of the cover 53 to be supported.

Projecting portions 53d and 53d serving to cover the recesses 52d and 52d for lapping tool insertion formed in the partition member 52 and to perform electric insulation of lapping pins, are integrally formed on the inner surface of the cover (FIG. 4).

Two projecting portions are formed so as to oppose to the recesses 52d and 52d formed at two locations of the partition member 52, respectively.

The base 60 is composed of, for example, the Edison type E26 and includes the cylindrical shell 61a with a screw thread and an eyelet 60c provided at a top portion of one end of the shell via an insulation portion 60b.

The shell 60a is constituted by a conductive metal and its other end is mounted on the outer circumferential surface of the lower end opening of the cover 53 and fixed by means of a heat resistant adhesive such as silicone resin or epoxy resin, or caulking.

The lighting device 40 is provided with the circuit board 40a in which electronic components 40b constituting the lighting circuit such as an inverter to light the arc tube by applying high-frequency power of 10 kHz or higher to the circuit board are mounted.

The circuit board 40a is constituted in a vertically long rectangular shape having an upper width wider than a lower width so that the upper portion is inserted into the space 52c of the partition member 52 and the lower portion is inserted into the base 60 in the longitudinal direction.

The circuit board 40a is fixed by fitting the edges of both sides in a width direction into the lock grooves 52f and 52f formed on the inner surface of the partition member 52 and the pair of lock grooves 53b and 53b formed on the inner surface of the cover 53 while the circuit board being kept in the longitudinal direction.

At this time, the circuit board 40a is arranged by leaning to one side relative to a central axis o-o of the holder 51, the partition member 52 and the cover 53 as shown in FIG. 2.

Incidentally, circuit patterns are formed on one side or both sides of the circuit board 40a, and a plurality of electronic components 40b constituting the lighting circuit such as lead components including electrolytic capacitors and chip components including transistors are mounted on the mounting surface of the circuit board 40a.

Further, a plurality of lapping pins 40c are provided by projecting from one side of the circuit board 40a, that is, the spatially narrower side of the circuit board arranged by leaning to one side. The lapping pins 40c constitute output terminals of the lighting circuit and the four, in total, outer wires w1 and w2, a pair of wires from each of the electrodes 20a and 20b of the arc tube, are wound around the lapping pins 40c for the electric connection. The four (two pairs) pins 40c are provided so as to project in the same direction.

On the spatially narrower side of the circuit board 40a arranged by leaning to one side, the cutout portion 53c of the cover 53 is positioned. The straight fine tube 21 is inserted, and the fine tube is arranged near the inner surface of the base 60.

A tip portion of the fine tube 21 in which the main amalgam 21a is sealed is bonded to the inner surface of the base 60 by means of a thermal conduction member 81 such as silicone resin or epoxy resin so as to improve the thermal conductivity.

The globe 70 is shaped like a PS type (Pear-shape type) bulb, having circular cross sectional view, used for the general lighting bulb such as an incandescent lamp and is formed to provide a smooth curved surface of a glass sphere of the general lighting bulb such as an incandescent lamp from glass material such as soda lime glass that is transparent or milk white with a light diffusion property, here milk white, in such a way that the arc tube 1 is covered.

That is, there is integrally formed the approximately cylindrical root portion N including a spherical portion 71 formed spherically with a maximum diameter portion 70a on the top end side and a reduced diameter portion 72 with a gradually decreasing diameter smaller than the diameter of the maximum diameter portion of the spherical portion at an opening end on the base end side.

Particularly, since the arc tube has, as described above, both the end portions 10b and 10c of the bulb having the spiral portion 10 that are opposed at positions inside the maximum outer diameter D1 of the spiral portion 10 with the minimum distance “a” between the opposing inner surfaces set to about 10 mm, the diameter of the holder 51 becomes smaller and, when the globe 70 covers the arc tube 1, the opposing root portion N of the globe 70 is guided along the small-diameter holder to form a more twisted shape.

The root portion N of the globe 70 has an opening end 73 formed on the base end side of the globe, and an edge of the opening end is fitted into the recess 51d formed in the flange portion 51c of the holder 51 and fixed by means of a heat resistant adhesive such as silicone resin or epoxy resin.

Next, a procedure for assembling the compact fluorescent lamp 30 of the structure mentioned above will be described.

First, the arc tube 1 is supported by the holder 51. That is, the lower end portions of both the end portions 10b and 10c of the arc tube 1 are inserted into the pair of bearing holes 51a and 51a of the holder 51, and an adhesive is injected from the inside of the holder so as to bond both the end portions of the arc tube 1 to the holder 51.

Then, the fine tubes 21 and 22 of the arc tube 1 and the outer wires w1 and w2 led to the inside of the holder 51 are inserted through the insertion holes 52e of the partition member 52 and the circuit board 40a is fixed by fitting the edges of both sides, in the width direction, into the pair of lock grooves 52f and 52f formed on the inner surface of the partition member 52 while the circuit board being kept in the longitudinal direction.

Next, as shown in FIG. 5, in the state in which the circuit board 40a is surely fixed to the partition member 52, an automatic machine for lapping is set and a lapping tool T is inserted from the recesses 52d and 52d of the partition member to wind the outer wires w1 and w2 around the four lapping pins 40c and soldered for connection.

At this time, since the recesses 52d and 52d are formed in the partition member 52, there is no need to perform lapping in an unstable state in which the circuit board 40a is pulled out of the partition member body 52.

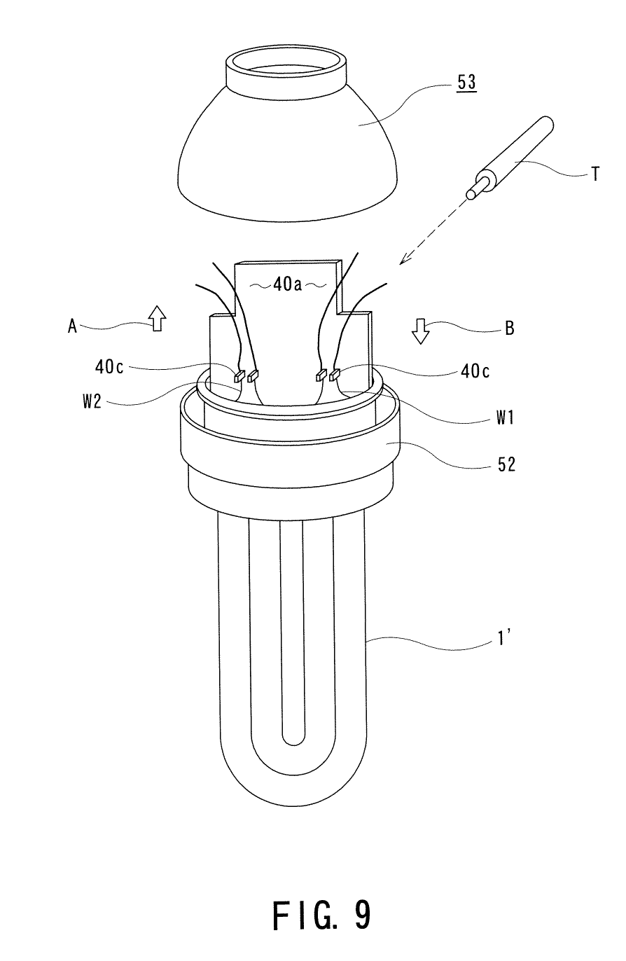

Incidentally, if there is no recess like a conventional example shown in FIG. 9 (U-shaped arc tube 1′ is used), the lapping pins 40c are hidden by sidewalls of the cylindrical portion of the partition member 52, thus making insertion of the lapping pins difficult.

Therefore, the circuit board 40a is pulled out of the partition member 52 so as to expose the lapping pins 40c to the outside from the sidewalls (arrow A in FIG. 9), and the lapping should be performed in this state. Thus, it becomes necessary for the lapping to be performed in an unstable state in which the circuit board 40a is pulled out of the partition member 52, which makes it difficult to carry out automatic operation and reliable connection, thus being inconvenient.

Further, since the circuit board 40a is put back to its normal position in the partition member 52 after the lapping operation (arrow B in FIG. 9), the outer wires w1 and w2 may become loose, making insufficient the exact electric insulation.

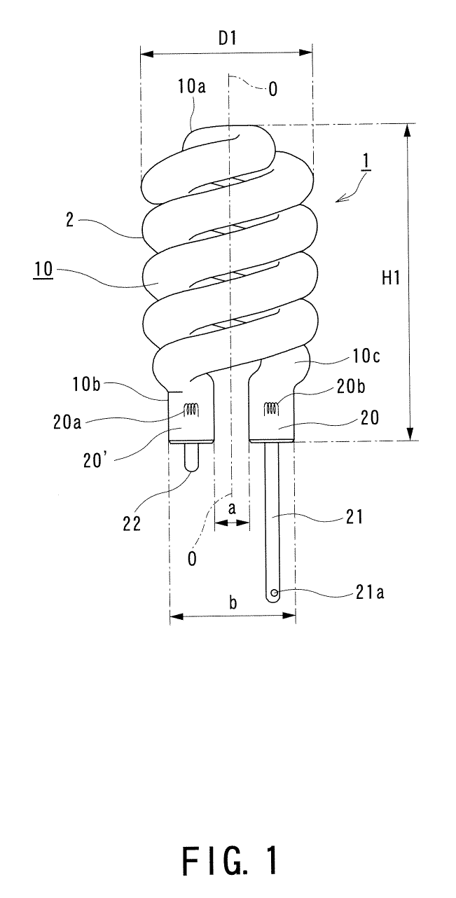

In FIG. 9 showing a conventional example, like reference numerals are added to elements or portions corresponding to those shown in FIG. 1 to FIG. 6.

The partition member 52 with the fixed circuit board 40a is inserted into the space 51b of the holder 51 supporting the arc tube 1 as described above, and the lower portion of the ring-shaped flange portion 51c of the holder 51 is fitted into the flange mounting portion 52b of the partition member 52 to integrally bond the partition member 52 and the holder 51 by means of heat resistant adhesive such as silicone resin or epoxy resin.

Further, the partition member 52 and holder 51 are inserted into the cover 53 in the integrated state. At this time, the flange-like mounting portion 52b of the partition member 52 is fitted into the mounting step portion 53a while fitting the lower edges on both sides of the circuit board 40a fixed to the partition member 52 into the pair of lock grooves 53b and 53b so as to integrally bond the integrated partition member 52 and holder 51 and the cover 53 by means of heat resistant adhesive such as silicone resin or epoxy resin.

The projecting portions 53d and 53d formed on the inner surface of the cover 53 are fitted to the recesses 52d and 52d formed in the partition member 52 for inserting the lapping tool so as to cover the recesses as shown in FIG. 2.

At the same time, the straight fine tube 21 of the arc tube 1 is inserted into the cutout portion 53c and locked thereto.

In this state, a heat shielding member 80 containing silicone resin, epoxy resin or the like is injected from the lower opening of the cover 53 to fill in the space defined by the inner circumferential surface of the cover and the circuit board 40a, electronic components 40b and the like.

Next, one lead wire connected to an input terminal of the circuit board 40a is connected to the eyelet 60c of the base 60 and the other lead wire is arranged at a base mounting portion formed on the outer circumferential surface of the lower opening of the cover 53.

In this state, a shell opening of the base 60 is fitted to the outer circumferential surface of the lower opening of the cover 53 to sandwich the lead wire therebetween, and further, the outer circumferential surface of the lower opening of the cover 53 is caulked from the outer circumferential surface of the opening of the shell 60a, and the other lead wire is electrically connected to the shell 60a.

Before fixing the base 60, the tip portion of the fine tube 21, the circuit board 40a, the electronic components 40b and the like are thermally connected by means of the thermal conduction member 81 such as silicone resin or epoxy resin by injecting the thermal conductive member 81 into the tip portion of the fine tube 21, the circuit board 40a, the electronic components 40b and the like. The thermal conduction member is then injected into the base and combining the base 60.

Next, the arc tube 1 is covered with the globe 70, and the edge of the opening end 73 of the globe is fitted into the recess 51d formed in the flange portion 51c of the holder 51 before the globe 70 being bonded by means of a heat resistant adhesive such as silicone resin or epoxy resin.

When mounting the globe 70, the inclining portion 51f of the holder 51 guides the corner edge of the opening end 73 of the globe along its inclined surface to smoothly cover the arc tube 1 so as not to chip the edge of the opening end 73 consisting of glass.

As shown in FIG. 3, the compact fluorescent lamp 30 constituted as described above has a height dimension H2 of the overall lamp including the base 60 of about 130 mm, an outer diameter D2 of the maximum diameter portion 70a of the globe 70 of about 65 mm, a diameter (outer diameter of the holder) D3 of a constricted portion of the neck of about 44 mm, a rated lamp power including circuit loss of about 21 W, and a total luminous flux of about 1500 lm or more. Thus, this compact fluorescent lamp 30 is usable by replacing it for a 100-W equivalent general incandescent lamp. Further, the diameter (outer diameter dimension of the holder) D3 of a constricted portion of the neck is preferably of 40 to 44 mm.

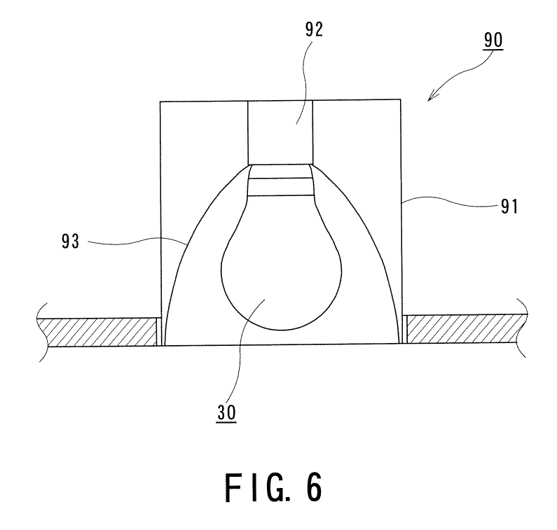

The compact fluorescent lamp 30 constituted as described above is usable, for example as shown in FIG. 6, in a downlight lighting apparatus 90.

The lighting apparatus 90 has an apparatus body 91, and an E26 type base compliant socket 92, to which the general incandescent lamp or the like is mounted, and a reflector 93 are mounted in the apparatus body. The compact fluorescent lamp 30 according to the present invention is inserted, instead of an incandescent lamp mounted to the socket 92.

If the compact fluorescent lamp is lightened instead of an incandescent lamp, the compact fluorescent lamp 30 is miniaturized up to a shape approximately identical to that of the general lighting bulb such as an incandescent lamp.

Therefore, the compact fluorescent lamp is surely screwed without the root portion being caught by the reflector, and the light distribution of the apparatus can be considered to be closely resembling or identical to the shape of the general lighting bulb such as an incandescent lamp.

Consequently, a sufficient amount of irradiation of light to the reflector 93 near the socket 92 disposed in the lighting apparatus is ensured, and apparatus characteristics according to an optical design of the reflector 93 designed for an incandescent lamp can be obtained.

According to the compact fluorescent lamp 30, as described above, a small-sized and highly efficient compact fluorescent lamp having an appearance closely resembling or identical to the shape of the general lighting bulb such as an incandescent lamp can be provided.

Therefore, a compact fluorescent lamp having general versatility to be able to replace an incandescent lamp can be provided as a light source of an incandescent lamp lighting apparatus. Accordingly, the rate of application to the lighting apparatus is still increased and, by using a compact fluorescent lamp instead of an incandescent lamp of a lighting apparatus, a power-saving and highly efficient lighting environment can be provided.

Particularly, the arc tube 1 has both the end portions 10b and 10c of the bulb having the spiral portion 10 that are opposed at the inside positions of the maximum outer diameter (D1) portion of the spiral portion 10 with the minimum distance “a” between the opposing inner surfaces set to about 10 mm.

Accordingly, the diameter of the holder 51 has become smaller and, when the globe 70 covers the arc tube 1, the opposing root portion N of the globe 70 is guided along the small holder 51 to form a more constricted shape, enabling a shape more closely resembling or identical to the shape of the general lighting bulb such as an incandescent lamp.

Even if the root portion N of the globe 70 is formed in a more constricted shape, the holder 51 is small and miniaturized, and therefore, the holder portion will neither cast a shadow to be reflected nor will the appearance be damaged.

Further, the holder 51 is shaped like a disc that forms the inclining portion 51f by cutting out the corner edges of the disc surface. Therefore, both the end portions 10b and 10c of the arc tube 1 are supported while facing the inclining portion 51f having the cut corner edges, and the light emitted from a vicinity of both the end portions (vicinity of the electrodes) is emitted downward without being blocked by the holder edges. Thus, the root portion N of the globe 70 will not be darkened, and the lighting having light distribution closely resembling or identical to that of an incandescent lamp can be set up.

Particularly, portions near the electrodes forming the root portion contain a portion which does not emit light, and thus, dark shadow likely appears. In this regard, if only the root portion is made thinner, a shadow is extremely likely to appear, but light at portions near both the end portions of the arc tube 1 can efficiently be utilized due to the inclined portion 51f to thereby cause sufficient light emission.

At the same time, since the holder 51 has no edge, the edge does not cast a shadow on the globe 70 to be reflected and the appearance is not damaged.

Further, since the spiral portion 10 of the arc tube 1 is positioned at the central portion of the lamp, a long discharge path consisting of the spiral portion can be ensured to increase luminous flux and improve luminous efficiency, thus enabling highly efficient lighting while providing sufficient brightness.

In addition, as described above, both the end portions 10b and 10c of the arc bulb 1 having the spiral portion 10 are opposed at positions inside the maximum outer diameter (D1) portion of the spiral portion 10 with the minimum distance “a” between the opposing inner surfaces set to about 10 mm. Therefore, the diameter of the holder 51 has become smaller, and a straight fine tube can be used as the fine tube 21 of the arc tube without being bent along the inner surface of the base as shown in the Patent Publication 2.

Accordingly, it is not necessary for the fine tube to be bent, and the fine tube can be made longer or shorter. The light flux rising properties can further be improved with excellent amalgam diffusion. In addition, workability of the fine tube is improved and fine tube strength becomes stronger.

Since the fine tube 21 is inserted into the cutout portion 53c formed in the inner circumferential surface of the lower opening of the cover 53 and then locked, the fine tube 21 can securely be supported, thus preventing damage.

At the same time, the fine tube 21 can be arranged at a position closer to the inner surface of the base 60 while maintaining the fine tube 21 to be straight to make preferred the thermal connection between the tip portion of the fine tube and the inner surface of the base. Thus, the improved emission efficiency to lower the temperature of the main amalgam 21a in the tip portion of the fine tube can be achieved. In addition, the amount of application of the thermal conduction material 81 such as silicone resin or epoxy resin for thermal connection can also be reduced.

Furthermore, the holder 51 supporting the arc tube 1 is constituted by metal made of aluminum, and the flange portion 51c exposed to the outer surface is integrally formed, so that the heat of the arc tube 1 is efficiently released to the outside and the thermal influence on the lighting circuit is controlled, thus improving the reliability of the electronic components.

The recesses 52d and 52d for inserting the lapping tool are formed in the partition member 52, and therefore, the lapping can be performed in the state that the circuit board 40a is securely fixed to the partition member 52 without being pulled out, as conventionally done, only by forming the recesses. Accordingly, automation also becomes possible, a process of shifting the circuit board becomes unnecessary, and the electric connection can be established reliably. Thus, the wiring work can be made easier and costs can be reducing.

Furthermore, the outer wires w1 and w2 are prevented from loosening, and therefore, the electric insulation can be sufficiently ensured and the coating of the insulating tubes to the outer wires can be omitted.

Still furthermore, since the recesses 52d and 52d are closed by the projecting portions 53d and 53d of the cover 53, the electric insulation mainly to the lapping portion is reliably performed, and at the same time, the intrusion of the heat from the arc tube 1 into the lighting circuit can be prevented to thereby further enhance the reliability of the electronic components.

### Second Embodiment

In this second embodiment, a second inclining portion is formed by applying white resin material such as silicone resin by using a free space on the upper surface of the holder formed by setting the minimum distance “a” between the opposing inner surfaces of both the end portions of the bulb to about 10 mm.

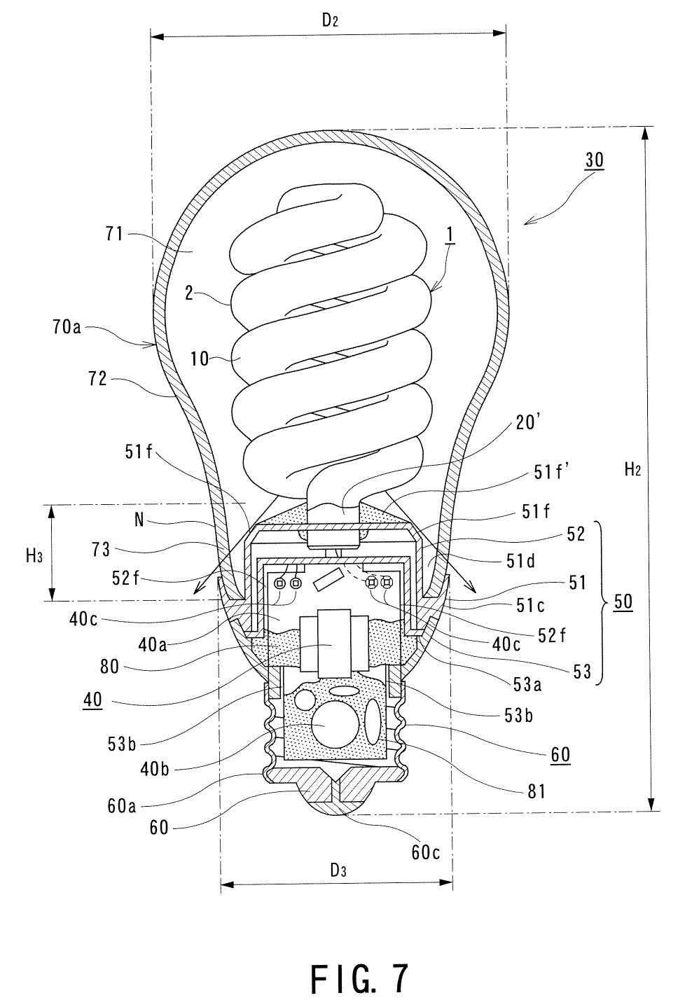

That is, as shown in FIG. 7, the second inclining portion 51f′ is formed by applying a material having excellent thermal conductivity such as silicone resin from both the end portions of the bulb 2 to the inclining portion 51f on the upper surface of the metal holder 51 in such a way that the inclining surface descends as the outer circumference gets nearer so as to be connected with the inclining portion. The upper surface of the holder is subjected to radiation measure.

Therefore, the heat of the arc tube 2 can be more easily transmitted to the holder 51.

The light emitted from the arc tube 1 is reflected by a white inclining surface made of silicone resin so as to irradiate a neck portion of the globe 70 being irradiated, and the shadow of the neck portion becomes hard to appear.

Light transmittance of a neck portion H3 (in this second embodiment, the height dimension from the opening end 73 of the globe to a portion where a straight portion of the reduced diameter portion 72 above the holder 51 starts) of the globe 70 in FIG. 7 is 1% to 5% lower than that of the top end side of the globe.

The height dimension H3 in this case is 10 to 20 mm. A narrow space is thereby formed between the holder 51 and the neck portion of the globe, and further, the reduction in light transmittance of 1% to 5% of the neck portion has no influence in terms of total luminous fluxes, making a shadow in the neck portion less conspicuous and preventing the total luminous fluxes from being reduced.

Incidentally, in the present embodiment, the inclining portion 51f may be omitted and an inclined portion may be formed only with the second inclined portion 51f′ formed by applying a material having excellent thermal conductivity such as silicone resin.

Further, in FIG. 7 showing the second embodiment, like reference numerals are added to elements or portions corresponding to those of the first embodiment mentioned with reference to FIG. 1 to FIG. 6.

It is to be noted that the compact fluorescent lamp of this second embodiment may be also applicable to a lighting apparatus of the structure shown in FIG. 6.

Next, modifications of the above embodiments will be described.

As mentioned hereinbefore, the compact fluorescent lamp corresponding to a 100-W type incandescent lamp is constituted in each embodiment. However, a low-power compact fluorescent lamp corresponding, for example, to the 40-W or 60-W type may be constituted. Alternately, a high-power compact fluorescent lamp may also be constituted.

Furthermore, a globe-less compact fluorescent lamp with the arc tube exposed may be constituted. In such case, there may obtain outside dimensions closely resembling or identical to those of the general lighting bulb such as an incandescent lamp, which further enhances the rate of application to various kinds of lighting apparatus.

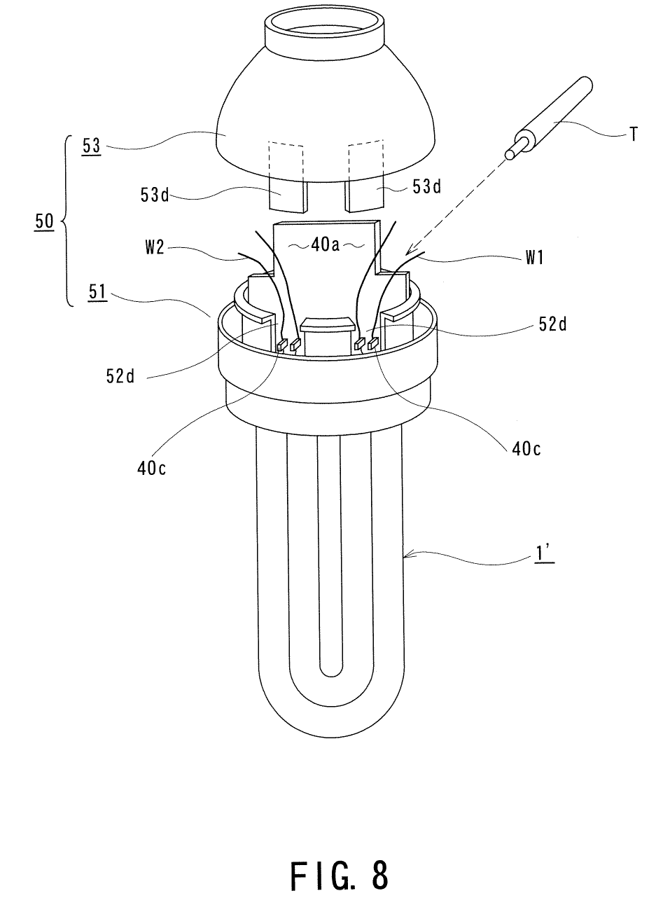

As shown in FIG. 8, the cover member 50 may be constituted to allow the holder 51 made, for example, of synthetic resin having electric insulation to directly support the circuit board 40a of the lighting device. In other words, the integral formation of the holder 51 and the partition member may eliminate the location of the partition member. This structure may be preferably applied to the low-power compact fluorescent lamp corresponding to the 40-W or 60-W type incandescent lamp.

In FIG. 8, like reference numerals are added to elements or portions corresponding to those FIG. 1 to FIG. 7 for description.

The globe 70 made of glass material may be substituted with translucent polycarbonate, for example.

The recesses 52d and 52d are formed in the partition member 52 and the outer wires w1 and w2 of the arc tube are electrically connected to the lapping pins 40c of the circuit board 40a by means of lapping. However, the electric connection is not limited to the lapping manner, and, for example, there may be utilized a method of connecting the outer wires to wires constituting terminals provided on the circuit board by soldering or welding, or a method of directly connecting outer wires to circuit patterns of the circuit board.

Furthermore, as shown in FIG. 8, each constitution and method, in which the recesses 52d and 52d are formed in the partition member 52 and outer wires of the arc tube and terminals of the circuit board 40a are electrically connected, may be applied, in addition to compact fluorescent lamps using an arc tube having a spiral portion, for example, to compact fluorescent lamps having one or a plurality of U-shaped arc tubes 1′.

Furthermore, a structure, in which the fine tube 21 is inserted into the cutout portion 53c formed in the inner circumferential surface of the lower opening of the cover 53 and then locked, and the fine tube 21 is arranged at a position closer to the inner surface of the base 60 while keeping the fine tube 21 straight, may be adopted to compact lamps having one or a plurality of U-shaped arc tubes in addition to compact fluorescent lamps using an arc tube having a spiral portion.

Still furthermore, the constitution, in which the inclining portion 51f is formed by cutting out the edges of the disc surface of the holder 51 into an approximately disc shape, and the second inclining portion 51f′ is added or only the second inclining portion 51f′ is used to remove darkened areas in the lamp root portion, may be applied to compact fluorescent lamps having one or a plurality of U-shaped arc tubes, in addition to compact fluorescent lamps using an arc tube having a spiral portion.

### Third Embodiment

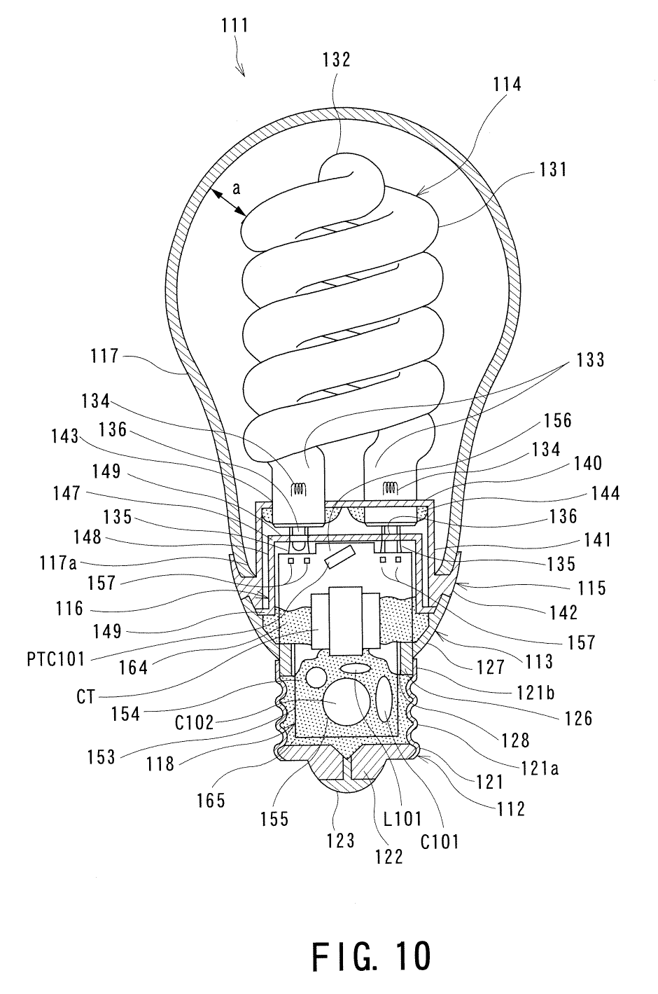

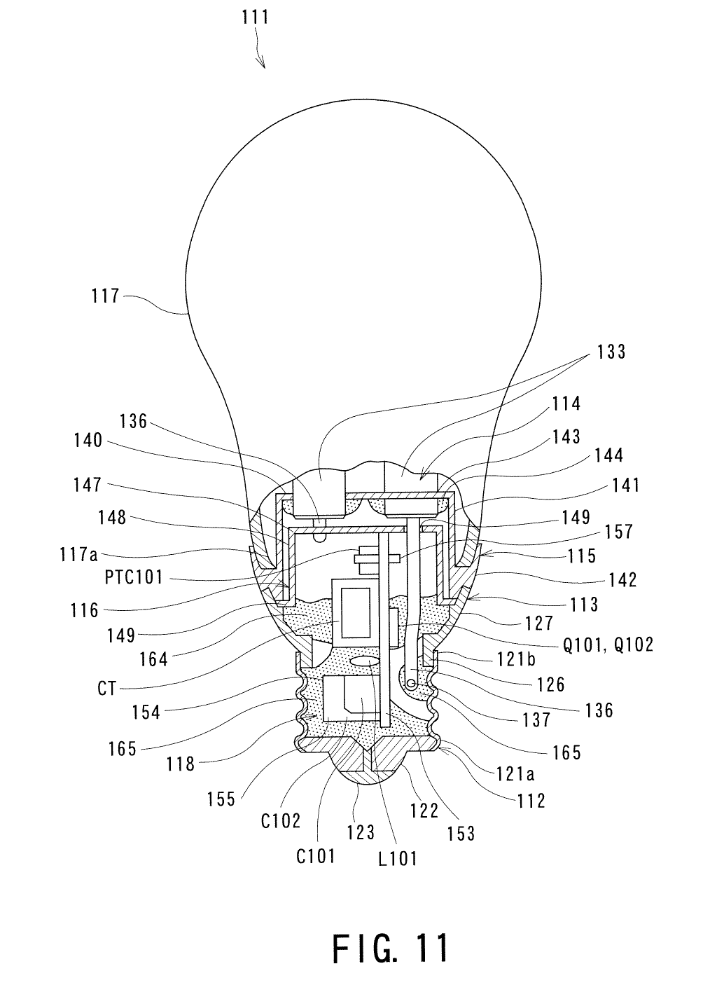

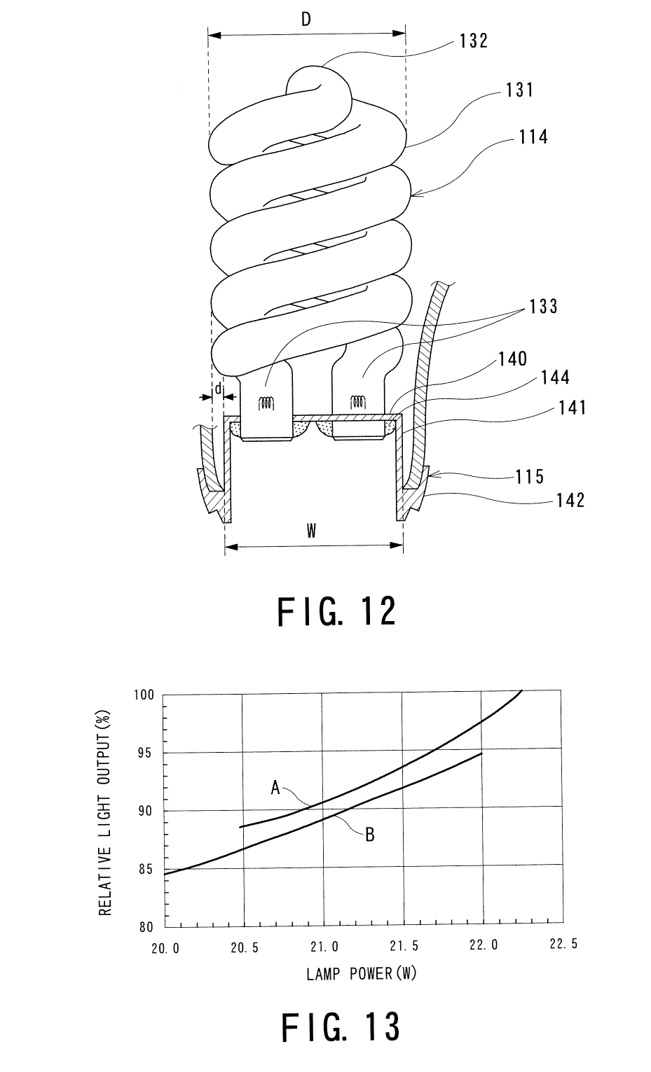

The third embodiment of the present invention will be described hereunder with reference to FIGS. 10 to 13.

With reference to FIGS. 10 to 12, a reference numeral 111 denotes a compact (self-ballasted) fluorescent lamp according to the third embodiment of the present invention.

The compact fluorescent lamp 111 includes a cover 113 having a base 112 at one end in a height direction, an arc tube 114 supported by the other end of the cover 113, a holder 115 made of metal mounted on the other end of the cover 113 supporting one end of the arc tube 114, a partition plate 116 made of synthetic resin provided so as to cover an inner surface of the holder 115, a globe 117 mounted on the holder 115 so as to cover the arc tube 114, and a lighting device 118 housed inside the base 112, cover 113 and holder 115.

As described above with reference to the first and second embodiments of the present invention, the outer appearance of this compact fluorescent lamp is formed approximately identical to that of the general lighting bulb such as an incandescent lamp having a rated power is, for example, 40-W type, 60-W type, and 100-W type. The general lighting bulb is defined by JIS C 7501.

The base 112 is, for example, Edison type E26 and includes a cylindrical shell 121 with a screw thread and an eyelet 123 provided at a top portion of one end of the shell 121 via an insulation portion 122. A thread portion 121a, which is a male thread, is formed on one end side of the shell 121, and a ring-shaped fixing portion 121b to be fixed to one end of the cover 113 by caulking or adhesion after putting the ring-shaped fixing portion 121b onto the one end, is formed on the other end side.

The cover 113 is formed of heat-resistant synthetic resin material such as PBT (polybutylene telephthalate). The cover 113 has, at one end, a cylindrical base mounting portion 126 to which the fixing portion 121b of the shell 121 of the base 112 is mounted, and has, at the other end, an expanding annular cover portion 127 is formed. A groove-like (channel-shaped) substrate holding portion 128 is formed at a position offset from a center line of the cover 113 inside the base mounting portion 126 along the center line of the cover 113.

The arc tube 114 is formed by bending a central region of the bulb 131 so as to provide two approximately equal portions of the one straight-tube bulb 131 and then spirally bending both the ends of the bulb 131 with the central region of the bent bulb 131 being as a top portion 132. The maximum spiral outer diameter D of the arc tube 114 is about 35 to 46 mm and about 37 mm in this embodiment.

The spiral bulb 131 is formed by bending the bulb 131 in the central region while the one straight-tube bulb 131 is softened by heat-melting and further winding both the ends of the bulb 131 along a spirally formed groove of a mold with the bent central region being maintained as the top portion 132. A pair of ends 133 of the bulb 131 project in parallel in a direction opposite to the top portion 132.

A three band phosphor, for example, is formed on the inner surface of the bulb 131 and filler (sealing) gases including rare gases such as argon (Ar), neon (Ne) and krypton (Kr), and mercury are sealed.

A pair of electrodes 134 are sealed by flare stems at the pair of ends 133 of the bulb 131. Each electrode 134 has a filament coil suspended by a pair of Dumet wires. The pair of Dumet wires are sealed, for example, in a flare stem and are led out of the flare stem so as to be connected to a pair of wires connected to the lighting device 118.

A cylindrical fine tube 136, which is also called an discharge tube, mounted in the flare stem projects from each of the ends 133 of the bulb 131 in a communicating state. Each of these fine tubes 136 is sealed one by one by fusing in a manufacturing process of the arc tube 114. The arc tube 114 is discharged through a portion that is not sealed among the fine tubes 136, which is sealed by fusing after filler gases are filled and substituted.

One of the fine tubes 136 is formed so long that its tip portion extends to the inner side of the base 112 and a main amalgam 137 is filled at the tip portion when sealing. The main amalgam 137 is an alloy of bismuth, tin and mercury, and is formed in an approximately spherical shape so as to control the mercury vapor pressure inside the arc tube 114 in a suitable range. In addition to the bismuth and tin, the main amalgam 137 may be formed as an alloy combining indium and lead. Moreover, a supplementary amalgam having a mercury adsorption/release function may be mounted to the Dumet wire of the electrode 134.

The holder 115 is formed, for example, from metallic material having excellent thermal conductivity such as aluminum and aluminum alloy and includes a disc-shaped holder portion 140, a cylindrical portion 141 projecting to one end from a perimeter portion of the holder portion 140, and an annular outer circumferential surface 142 projecting outward from one end of the cylindrical portion 141.

The maximum outer diameter W of the holder 115 is 30 to 40 mm, and about 35 mm in this embodiment. Accordingly, a gap of the dimension “d” between the circumferential side of the cylindrical portion 141 of the holder 115 and the outer circumferential edge of the arc tube 114 may be taken to be 1 to 5 mm.

The holder portion 140 has a pair of insertion holes 143 formed therein so that the pair of ends 133 of the arc tube 114 are inserted thereinto. The arc tube 114 is bonded to the holder 115 by injecting an adhesive 144 such as silicone resin or epoxy resin from the inside of the cylindrical portion 141, while the pair of the ends 133 of the arc tube 114 being inserted through the pair of insertion holes 143.

One end of the outer circumferential surface 142 is fitted into the other end of the cover portion 127 of the cover 113 for mounting, and the other end is formed by expanding the opening. The globe 117 is mounted to the other end. Therefore, the outer circumferential surface 142 is exposed to the outside between the cover 113 and the globe 117 and constitutes an outer appearance of the compact fluorescent lamp 111 together with the cover 113 and the globe 117.

The holder 115 is made of aluminum so as to provide a very high reflectivity of light, and the surfaces of the holder portion 140 and the cylindrical portion 141 are constituted as reflecting surfaces.

The partition plate 116 is formed of heat-resistant synthetic resin material such as PBT (polybutylene telephthalate) and includes a disc-shaped partition plate 147, a cylindrical portion 148 projecting to one end from a perimeter portion of the partition plate 147, and a mounting portion 149 projecting outward from one end of the cylindrical portion 148. The mounting portion 149 is sandwiched between the cover 113 and the holder 115 and may be bonded by an adhesive having a viscosity such as silicone resin or epoxy resin.

The partition plate 147 has a pair of insertion holes 150 formed therein, through which each fine tube of the arc tube 114 and wires 135 are inserted. Though not shown, a groove-like substrate holding portion is formed at a position offset from the center line of the partition plate 116 inside the cylindrical portion 148 along the center line of the partition plate 116.

The globe 117 is formed of a material such as transparent glass or glass having a light diffusion property and synthetic resin so as to provide a smooth curved surface of a spherical glass of the general lighting bulb such as an incandescent lamp.

The globe 117 has an opening 117a formed on one end and an edge of the opening 117a is fitted to the inside of the cover portion 127 of the holder 115 and then bonded by means of heat resistant adhesive having a viscosity such as silicone resin or epoxy resin.

The shortest distance “a” between the inner surface of the globe 117 and the arc tube 114 is set to be 2 to 5 mm. If a vibration in a transverse direction is applied to the compact fluorescent lamp 111, the arc tube 114 will also vibrates in the transverse direction. However, since the arc tube 114 vibrates with the holder 115 acting as a fulcrum, amplitudes on the top portion side will become greater. In view of this matter, by setting the shortest distance “a” to 2 to 5 mm, the top portion of the arc tube 114 can be prevented from coming into contact with the inner surface of the globe 117 and causing damage even if the compact fluorescent lamp 111 vibrates in the transverse direction.

The lighting device 118 has a substrate 153, and a plurality of electronic components 155 constituting a lighting circuit 154 are mounted on the substrate 153. The substrate 153 is formed to be narrower on the base (112) side than the cover (113) side, and the base side is formed in a width dimension so as to enable the insertion of the base side into the base 112, so that the substrate 153 provides an approximately rectangular shape with the height dimension longer than the width dimension.

Furthermore, both the side edge portions of the substrate 153 are inserted into and engaged with a pair of substrate mounting portions 128 of the cover 113 and a pair of the substrate mounting portions of the partition plate 116 so as to provide a vertical arrangement of the substrate 153 along the central axis of the cover 113 and the partition plate 116 at the position offset with respect to the center lines of the cover 113 and the partition plate 116.

That is, in a state in which the base 112, the cover 113, the holder 115 and the partition plate 116 are combined, the substrate 153 is arranged to be upright along the center line of the base 112 with respect to the inner surface of the base 112 and also arranged at a position offset with respect to the center line of the base 112.

On the other end side of the substrate 153, i.e., the arc tube (114) side, a projecting portion 156 in contact with the partition plate 116 is formed in the central position by projecting from the other end. Further, on both the sides of the projecting portion 156, there are provided four projecting lapping pins 157, around which a pair of wires 135 of each of the electrodes 134 of the arc tube 114 are wound for connection. The substrate 153 in the height direction is positioned and held by connecting the wires 135 of the arc tube 114 and the lapping pins 157, or sandwiching between the base 112 and the partition plate 116.

Next, in order to assemble the compact fluorescent lamp 111, each end 133 on the one end side of the arc tube 114 is inserted into each insertion hole 143 of the holder 115, and the adhesive 144 is injected from the inside of the holder 115 so as to bond the each end 133 of the arc tube 114 to the holder 115.

The fine tubes 136 led into the holder 115 and projecting from the respective ends 133 of the arc tube 114 and the wires 135 are inserted through the insertion holes 150 of the partition plate 116, which is then inserted into the holder 115.

The edges on both the sides of the substrate 153 are inserted into the substrate mounting portion of the partition plate 116, and the wire 135 of the arc tube 114 led into the inside of the partition plate 116 is wound around the lapping pin 157 of the substrate 153 for connection.

The holder 115 and the cover 113 are combined for bonding. A heat shielding member 164 is injected so as to fill in an opening between the inner circumferential surface of the cover 113, and the substrate 153 and the electronic components 155.

One lead wire, not shown, connected to an input portion of the substrate 153 is connected to the eyelet 123 of the base 112, and the other one lead wire is arranged at the base mounting portion 126 of the cover 113. The tip portion of this other lead wire is sandwiched by fitting the fixing portion 121b of the shell 121 of the base 112 to the outer circumference of the base mounting portion 126, and the fixing portion 121b of the shell 121 is fixed to the base mounting portion 126 of the cover 113 by caulking to thereby connect the other lead wire to the shell 121 electrically and mechanically.

Before combining the base 112, the tip end portion of the fine tube 136, the board 153, the electronic components 155, and the base 112 are thermally connected to a thermal conduction member 165 by injecting the thermal conductive material 165 into the tip portion of the fine tube 136, the board 153, and the electronic components 155 housed in the base 112 or by injecting the thermal conductive material 165 into the base 112 and combining the base 112.

The arc tube 114 is covered with the globe 117 and the globe 117 is bonded to the holder 115 by means of adhesive.

The compact fluorescent lamp 111 constituted as described above has the maximum outer diameter of the globe of about 65 mm, a height dimension of the overall lamp including the base 112 of about 133 mm, a lamp power including circuit loss of about 23 W or less, and a total of luminous fluxes of about 1500 lm or more, and thus, can be used by replacing a 100-W equivalent general incandescent lamp.

The compact fluorescent lamp of this embodiment may be also applicable to a downlight lighting apparatus, which has substantially the same outer configuration of that of FIG. 6 described in connection with the first embodiment of the compact fluorescent lamp of the present invention. That is, the lighting apparatus includes an apparatus body, in which a socket and a reflector are mounted, and the compact fluorescent lamp of the structure mentioned above is inserted into the socket.

According to the third embodiment of the compact fluorescent lamp 111, it is formed so as to have the maximum outer diameter W of the cylindrical portion 141 of the holder 115 smaller than the maximum spiral outer diameter D of the arc tube 114. It becomes hence possible to form the outer circumferential surface of the holder 115 and the outer diameter dimension of the cover 113 to be smaller, thereby providing the compact fluorescent lamp 111 miniaturized in such a way that the outer diameter dimension becomes smaller as the base 112 gets nearer like a general incandescent lamp.

Furthermore, the circumferential side of the cylindrical portion 141 of the holder 115 is irradiated with the light emitted from the arc tube 114, and the light is also emitted from surroundings of the cylindrical portion due to the light emitted directly from the vicinity of circumferential side and the light reflected from the circumferential side and the like. Accordingly, the appearance of the lighting can be made similar to an image of a general incandescent lamp, thus improving merchantability.

In addition, the substrate 153 formed in a width dimension so as to be inserted into the base 112 is arranged to be upright along the center line of the base 112. Therefore, the substrate 153 and the electronic components 155 can be arranged inside the base 112 to miniaturize the cover 113.

By arranging the substrate 153 at a position offset with respect to the center line of the base 112, an electronic component 155 having a large size can be arranged in a wider space between the substrate 153 and the base 112. Therefore, the lighting device 118 can efficiently be housed inside the base 112, thereby miniaturizing the cover 113 and the like. Particularly, a trans-CT, for example, tends to become larger with increasing windings accompanying a higher power output and such large-sized trans-CT can be arranged in a wider space between the substrate 153 and the base 112.

Furthermore, the tip portion of the fine tube 136 of the arc tube 114, in which the main amalgam 137 is sealed, can be arranged between the base 112 and the substrate 153 by arranging the substrate 153 formed in a width dimension so as to be inserted into the base 112 to be upright along the center line of the base 112. Therefore, the lighting device 118 and the fine tube 136 can efficiently be arranged inside the base 112 while reducing an influence of heat from the arc tube 114 during the lighting on the main amalgam 137, thereby miniaturizing the cover 113.

Moreover, the substrate 153 is arranged at a position offset with respect to the center line of the base 112, and the fine tube 136, in which the main amalgam 137 is filled, is arranged on the narrower side of the space between the board 153 and the base 112. Accordingly, the large electronic components 155 can be arranged on a wider side of the space between the substrate 153 and the base 112, and in addition, the lighting device 118 and the fine tube 136 in which the main amalgam 137 is filled can efficiently be arranged inside the base 112.

With the thermal conductive material 165 arranged inside the base 112 so as to thermally connect the substrate 153 to the base 112, the heat of the electronic components 155 can efficiently be transmitted from the substrate 153 to the base 112, thereby improving a heat radiation property.

Furthermore, with the holder 115 made of metal mounted in a state in which the holder 115 is exposed from the cover 113 on the other end side of the cover 113, the heat of the arc tube 114 supported by the holder 115 can efficiently be released to the outside, and the heat inside the cover 113 can efficiently be released to the outside, thus lowering the temperature of the electronic components 155 and the substrate 153.

If the tip portion of the fine tube 136, in which the main amalgam 137 is sealed, the electronic components 155 and the base 112 are thermally connected to the thermal conductive material 165 inside the base 112, the heat of the electronic components 155 can efficiently be transmitted to the base 112 for dissipation.

If the temperature of the tip portion of the fine tube 136 becomes low when lightened, for example, with the base 112 side being directed downward, the heat from the electronic components 155 is transmitted to the tip portion of the fine tube 136. Therefore, the temperature of the tip portion of the fine tube 136 is maintained uniformly by means of the thermal conductive material, preventing reduction of the total of luminous fluxes.

By thermally blocking the base 112 and the arc tube 114 by the heat shielding member 164 and thermally connecting the tip portion of the fine tube 136, a portion of the electronic components 155, and the base 112 by the thermal conductive material 165, the temperature of the tip portion of the fine tube 136, the electronic components 155 and the like inside the base 112 can be maintained uniformly and the total luminous fluxes and the light emission efficiency can be maintained constant, regardless of the orientation of the base 112 of the compact fluorescent lamp 111 in, for example, downward, upward or horizontal direction.

As described above, the compact fluorescent lamp 111 of this embodiment provides an appearance approximately identical to that of the general lighting bulb such as an incandescent lamp, offers stable luminous fluxes and light emission efficiency regardless of the orientation of the compact fluorescent lamp 111, and increases the rate of application to the lighting apparatus using the general lighting bulb such as an incandescent lamp.

Further, although the compact fluorescent lamp 111 in this embodiment is provided with the globe 117 covering the arc tube 114, the globe 117 may be eliminated so that the arc tube 114 is exposed. In this case, outside dimensions approximately identical to those of the general lighting bulb such as an incandescent lamp may be obtained, and the rate of application to the lighting apparatus using the general lighting bulb such as an incandescent lamp will be improved.

Hereunder with reference to FIG. 13, illumination efficiency at the time when the outer peripheral surface of the cylindrical portion 141 of the holder portion 140 is coated with white according to this embodiment will be explained.

FIG. 13 is a graph representing a variation of the illumination efficiency in the case when the white coating is made to the outer peripheral surface of the cylindrical portion 141 of the holder 115 of the compact fluorescent lamp 111 of this embodiment. The horizontal axis of the graph represents an inputted power and the vertical axis of the graph represents a relative value of the illumination efficiency, in which line A shows a case that the while coating is made on the outer peripheral surface of the cylindrical portion 141 of the holder, and lime B shows a case that such white coating is not made and a material aluminum is exposed outward. Further, in the graph, the value 100% in the vertical axis indicates the maximum value of the line A obtained in the experiment.

The inventors of the subject application confirmed the following matter. That is, in order to reduce the loss of the lighting, an experiment was performed by applying the white coating on the outer surface of the holder portion 140 and the cylindrical portion 141 of an aluminum die-cast holder 115. In the experiment, respectively fifteen normal products to which no while color was coated and white cooler coated products were prepared, and full light fluxes were measured after 100 hours lightening per each power inputting. As a result, as represented by the lines A and B in FIG. 13, approximately 2% difference in the illumination efficiency was confirmed.

Especially, a double-spiral arc tube has a shape capable of having a long discharge length, and although the illumination efficiency may be high, a light take-out efficiency is not sufficient in a combination of a partition plate and an outer tube globe. In addition, in a compact and high-density type, specifically, a high luminous type arc tube over 20 W, it is effective to use a metallic partition plate such as holder portion 140 for reducing a thermal stress in an electronic circuit. In such case, as smaller the area of the disc-shaped holder portion 140 is, the effective useful ratio of the light radiated from the mainly inward winding of the spiral arc tube 114 and advancing in the direction of the holder portion 140 is more improved, thus being advantageous.

In the case of the arc tube in which the U-shaped bent bulbs are connected, as the width of the illuminating portion and the width of the end portion accord with each other, it is difficult to make smaller the width of the holder portion 140 than the width of the arc tube. However, in the case of the spiral arc tube 114 of this embodiment, the distance between the end portions 133 can be made smaller, the width of the holder portion 140 can be made small, thus being effective and usable.

It is further to be noted that the present invention is not limited to the described embodiments and many other changes and modifications may be made without departing from the scopes of the appended claims.

What is claimed is:

1. A compact fluorescent lamp comprising:
an arc tube having a bulb with a spiral portion formed in at least a portion thereof, the bulb having an electrode sealed in each of both end portions thereof so as to form a discharge path inside, and both the end portions of the bulb opposing to each other at positions inside a portion having a maximum outer diameter of the spiral portion so that the opposing end portions have a minimum distance of 5 to 15 mm;
a lighting device lightening the arc tube;
a cover member which supports the arc tube and in which the lighting device is arranged; and
a base supported by the cover member.

2. The compact fluorescent lamp according to claim 1, wherein the bulb is provided with a straight fine tube having one end communicating with an inside of the bulb on at least one electrode sealing portion and another end sealed to fill an amalgam therein.

3. The compact fluorescent lamp according to claim 1, wherein the cover member includes a holder having a portion exposed to an outside and formed of a material having thermal conductivity and supports the arc tube, a partition member supporting a circuit board of the lighting device, and a cover supporting the base.

4. The compact fluorescent lamp according to claim 3, wherein the holder has substantially a disc shape with an inclined portion formed in an outer periphery thereof by cutting out edges of the disc and a flange portion exposed outward, and the holder supports the arc tube on a disc surface and the globe on an inner surface of the flange portion.

5. A lighting apparatus comprising:
an apparatus body;
a socket provided in the apparatus body; and
a compact fluorescent lamp having connected to the socket,
the compact fluorescent lamp including: an arc tube having a bulb with a spiral portion formed in at least a portion thereof, the bulb having an electrode sealed in each of both end portions thereof so as to form a discharge path inside, and both the end portions of the bulb opposing to each other at positions inside a portion having a maximum outer diameter of the spiral portion so that the opposing end portions have a minimum distance of 5 to 15 mm; a lighting device lightening the arc tube; a cover member which supports the arc tube and in which the lighting device is arranged, and a base supported by the cover member.

6. A compact fluorescent lamp comprising:
an arc tube spirally formed with a maximum spiral outer diameter;
a cover member mounted with a base on one end side, the arc tube being supported on another end side;
a holder made of metal having an annular outer peripheral surface having a portion mounted on the other end side of the cover member, which is outwardly exposed, and a cylindrical portion integrally formed with an inside of the outer peripheral surface and projecting on the other end side over the outer peripheral surface, the cylindrical portion being formed in such a way that a maximum outer diameter thereof is smaller than the maximum spiral outer diameter of the arc tube, and the arc tube being supported by the cylindrical portion so as to project toward the other end side; and
a lighting device having a substrate mounted with an electronic component constituting a lighting circuit which lights the arc tube, the lighting device being arranged inside the cover member.

7. The compact fluorescent lamp according to claim 6, wherein the difference between the maximum outer diameter W of the cylindrical portion and the maximum spiral outer diameter D of the arc tube is 2 to 10 mm.

8. The compact fluorescent lamp according to claim 6, wherein the cylindrical portion of the holder is coated in white.

9. A lighting apparatus comprising:
an apparatus body;
a socket mounted to the apparatus body; and
a compact self-ballasted fluorescent lamp mounted to the socket,
the compact fluorescent lamp including: an arc tube spirally formed with a maximum spiral outer diameter; a cover member mounted with a base on one end side, the arc tube being supported on another end side; a holder made of metal having an annular outer peripheral surface having a portion mounted on the other end side of the cover member, which is outwardly exposed, and a cylindrical portion integrally formed with an inside of the outer peripheral surface and projecting on the other end side over the outer peripheral surface, the cylindrical portion being formed in such a way that a maximum outer diameter thereof is smaller than the maximum spiral outer diameter of the arc tube, and the arc tube being supported by the cylindrical portion so as to project toward the other end side; and a lighting device having a substrate mounted with an electronic component constituting a lighting circuit which lights the arc tube, the lighting device being arranged inside the cover member.
